(19) United States
(12) Patent Application Publication
(10) Pub. No.: US 2007/0145074 A1
(43) Pub. Date: Jun. 28, 2007

(54) Beverage and aroma dispenser

(75) Inventor: E. Scott Sevcik, Crystal Lake, IL (US)

Correspondence Address: PYLE & PIONTEK LLC, 221 N. LASALLE STREET,, SUITE 2036, CHICAGO, IL, 60601, US

(73) Assignee: IMI Cornelius, Glendale Heights, IL (US)

(21) Appl. No.: 11/645,379

(22) Filed: Dec. 26, 2006

Related U.S. Application Data
(60) Provisional application No. 60/754,345, filed on Dec. 28, 2005.

(51) Int. Cl. B67D 5/56; A62B 7/08

(52) U.S. Cl. 222/129.1; 422/124

(57) ABSTRACT

A beverage dispenser is characterized by a beverage dispensing station having a valve for dispensing a beverage while a flow of air is contacted with the beverage being dispensed to entrain in the air an aroma of the beverage for dissemination of the aroma to a customer or another selected area. The airflow can be generated by a fan contained within a housing of the beverage dispensing station.

This application claims benefit of provisional application Ser. No. 60/754,345, filed Dec. 28, 2005.

### FIELD OF THE INVENTION

The present invention relates to beverage dispensers, and in particular to a beverage dispenser for dispensing a beverage while simultaneously disseminating an aroma of the beverage.

### BACKGROUND OF THE INVENTION

Beverage dispensers are well known in the art and are commonly used to dispense beverages such as soft drinks, coffee, fruit juice, etc. Some beverage dispensers are of a type that are supplied with a complete or fully constituted beverage, such as a fruit juice, for dispensing from a dispense valve into a cup. Other beverage dispensers are supplied with separate beverage components or ingredients, such as concentrate beverage syrups and diluents for the syrups. In the case of soft drinks, the diluents are normally carbonated and still water, and the concentrate syrups and diluents may be delivered to a post-mix valve of the beverage dispenser for admixture and dispensing into a cup. Alternatively, the concentrate syrups and diluents may be dispensed seriatim from a dispense valve as separate fluid flows that are brought together and mixed in a cup, or beverage syrup may be directed into a cup at one dispense location and diluent added to the cup at another dispense location.

A pleasurable part of a dining experience is the olfactory enjoyment of the aroma of food being prepared for consumption. That sensory experience, however, is normally not present when beverages are prepared, such as in the preparation soft-drink beverages. The traditional method of dispensing a beverage is out of a faucet, valve or nozzle, and at the point of dispense the beverage is directed into a cup and typically sealed with a lid. This prevents the consumer from experiencing the true aroma of the beverage.

It would therefore be desirable to enable consumers to enjoy the aroma of beverages being dispensed, just as a diner experiences the olfactory enjoyment of the aroma of food being prepared.

### OBJECT OF THE INVENTION

A primary object of the present invention is to provide a beverage dispenser that, when dispensing of a beverage, also disseminates an aroma of the beverage.

### SUMMARY OF THE INVENTION

In accordance with the present invention, a beverage dispenser comprises a beverage dispensing valve; means for delivering beverage to the valve for being dispensed from the valve; means for generating a flow of air that contacts the beverage being dispensed from the valve to entrain in the air an aroma of the beverage; and means for disseminating the beverage aroma entraining air.

In a one embodiment of the beverage dispenser, the airflow generating means generates a flow of air that generally surrounds the beverage being dispensed and the means for disseminating the aroma directs the aroma entraining air toward a desired location. The beverage delivering means can deliver concentrate beverage syrup to the valve, and the generating means generates a flow of air that contacts the concentrate beverage syrup being dispensed from the valve to entrain in the air the aroma of the syrup. Alternatively, the beverage delivering means can deliver both concentrate beverage syrup and diluent for the syrup to the valve, in which case the airflow generating means generates a flow of air in contact the concentrate syrup and diluent being dispensed from the valve.

The means for delivering beverage to the beverage dispensing valve can comprise a beverage delivery system for connection to a plurality of supplies of concentrate beverage syrup, along with metering pump means for delivering predetermined amounts of the concentrate syrups to the beverage dispensing valve. The beverage delivery system can also include a carbonator for delivering carbonated water to the beverage dispensing valve, and the beverage dispensing valve may be mounted within an interior of a housing that has means for admitting air into the housing interior, means for exhausting air from the housing interior, and air motive means for moving ambient air through the air admitting means into, through and out of the housing interior through the air exhausting means in a direction for contact of the exhausted air with beverage being dispensed from the beverage dispensing valve. The air motive means can be a fan, and one of the air exhausting means and air admitting means can comprise an opening from the housing interior that is in surrounding relationship with an outlet from the beverage dispensing valve for a flow of air in surrounding relationship with beverage being dispensed from the valve.

The invention also contemplates a method of dispensing beverage, comprising the steps of delivering beverage to a beverage dispensing valve; dispensing beverage from the valve; generating a flow of air that contacts beverage being dispensed from the valve to entrain in the air an aroma of the beverage; and disseminating the aroma entraining air.

In one practice of the method of the invention, the generating step generates an airflow that generally surrounds the beverage while the beverage is being dispensed from the valve, and the disseminating step directs the beverage aroma entraining air toward a desired location. The delivering step can either deliver concentrate beverage syrup by itself to the dispensing valve, with the generating step then generating a flow of air that contacts the concentrate syrup being dispensed from the valve, or the delivering step can deliver both concentrate beverage syrup and diluent for the syrup to the beverage dispensing valve, with the generating step then generating a flow of air that contacts the concentrate syrup and diluent being dispensed from the valve. The delivering step can include the steps of coupling a plurality of supplies of concentrate beverage syrup to the beverage dispensing valve, and using metering pumps to deliver predetermined amounts of the concentrate syrups to the valve. The delivering step can further include the step of coupling a carbonator to the beverage dispensing valve.

The invention finds use with a beverage dispensing station, and the method includes the further steps of mounting the beverage dispensing valve in an interior of a housing; providing an entry for air into the housing interior; providing an exit for air from the housing interior; and moving ambient air through the air entry into, through and out of the housing interior through the air exit in a direction for contact of the air with the beverage being dispensed from the beverage dispensing valve. The ambient air moving step can be performed with a fan, and one of the air admitting and air exit steps can include providing an opening from the housing in surrounding relationship with an outlet from the beverage dispensing valve for a flow of air in surrounding relationship with beverage being dispensed from the valve.

The foregoing and other objects, advantages and features of the invention will become apparent upon consideration of the following detailed description, when taken in conjunction with the accompanying drawings.

### BRIEF DESCRIPTION OF THE DRAWINGS

FIG. 1 is a perspective view of a beverage dispensing station of a type with which the teachings of the present invention may be used;

FIG. 2 is an exploded assembly view of the beverage dispensing station of FIG. 1, and

FIG. 3 is a schematic representation of a system for supplying concentrate beverage syrups and diluents to the beverage dispensing station.

### DETAILED DESCRIPTION

The invention provides an improved beverage dispenser that disseminates the aroma of a beverage being dispensed simultaneous with and incident to dispensing of the beverage. In a contemplated use of the dispenser, the beverage being dispensed is a soft drink that is constituted by combining concentrate beverage syrup and diluent, and the aroma of the concentrate beverage syrup is picked up by and entrained in an airflow and disseminated by the airflow. While for convenience the invention will be described in connection with dispensing soft drinks, it is understood that the teachings of the invention may also be applied to dispensing and disseminating the aroma of beverages other than soft drinks, such as of coffee, tea, fruit juice, etc.

As will be described in greater detail, dissemination of the aroma of beverage syrup is accomplished by directing a flow of air, which may be provided by means of a fan, pressurized gas or other propelling device, to a customer or other targeted area, after first contacting the airflow against, and advantageously by passing the airflow in surrounding relationship around, the beverage as it is being dispensed into a cup. Disseminating the aroma of a beverage being dispensed offers improvements over the traditional method of dispensing a beverage, wherein at the point of dispense the beverage is flowed into a cup without first picking up an aroma of the beverage for dissemination and, typically, the cup is sealed with a lid, thereby preventing the consumer from experiencing the true aroma of the beverage. In practice of the invention, disseminating the aroma provides an enhanced olfactory experience at the point of dispense, since the consumer is able to appreciate the smell of the beverage as it is being prepared. The invention also advantageously provides a retail outlet with a means for differentiating its brand product from other typical brands, to thereby attract more sales.

The strength of the aroma of beverage syrup is dependent upon the degree of concentration and the formulation of the syrup, and can be controlled and/or enhanced by controlling the concentration and formulation of the syrup, such that a more concentrated syrup has a stronger aroma, or such that a syrup may be provided with a specific aroma or be specially formulated to have a stronger aroma. More concentrated syrup requires less storage space for a given number of beverages to be prepared from the syrup, which advantageously yields economies in terms of shipping and storage of the syrup. The beverage syrups providing the aroma are typically stored in bag-in-box type containers, and are pumped or otherwise propelled or delivered to a point of dispense in response to actuation of a keypad or lever of the beverage dispenser. The syrups can be mixed with diluent either before or after being directed into a cup.

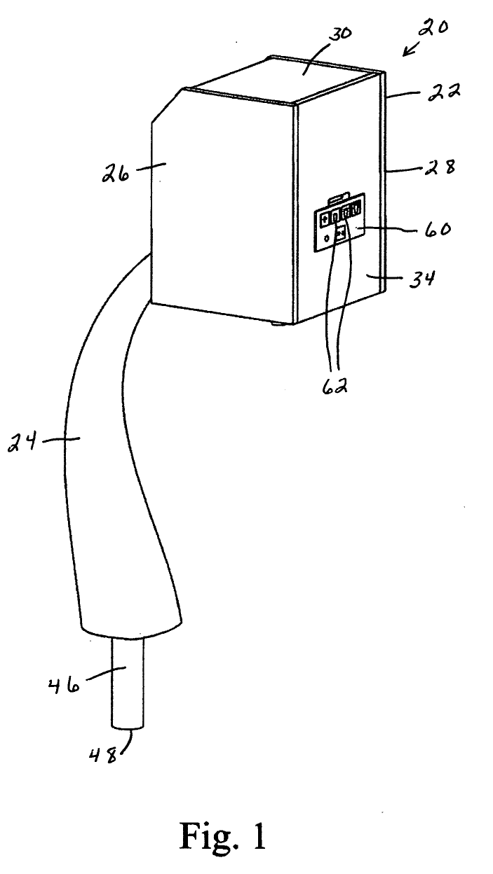

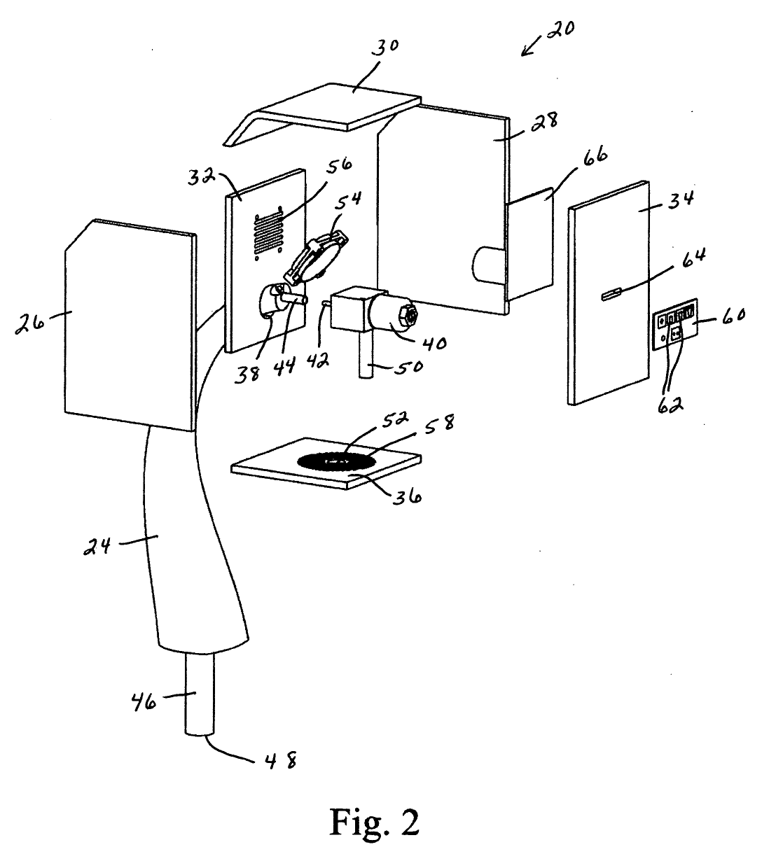

Referring to the drawings, FIGS. 1 and 2 show a beverage dispensing station, indicated generally at 20, of a type that may be used in practice of the present invention. The beverage dispensing station may be part of a beverage dispenser cabinet or countertop mounted, and includes a beverage dispensing head 22 carried at an upper end of a support arm 24. The dispensing head 22 has an outer housing that may conveniently be formed by a plurality of separate wall portions, including a pair of side walls 26 and 28, a top wall 30, a back wall 32, a front wall 34 and a bottom wall 36. The back wall 32 has an opening 38 for receiving the upper end of the support arm 24, and any suitable means (not shown) may be provided for attaching the back wall to the support arm, whereby the dispensing head 22 is mounted on and carried at the upper end of the support arm. A lower end of the support arm 24 may be attached to a countertop or other suitable support (neither shown).

Contained within the dispensing head 22 is a beverage dispensing valve or faucet 40 having an inlet 42 fluid coupled to an upper outlet end 44 of a tube 46 extending through the support arm 24. A lower inlet end 48 to the tube 46 is connected to supplies of beverage components which, as will be described, may comprise supplies of concentrate beverage syrups and diluents for the syrups, so that the beverage components may be delivered to the inlet 42 to the valve 40. An outlet 50 from the beverage valve 40 extends downward through an opening 52 in the housing bottom wall 36 to the lower exterior of the beverage dispensing head 22, to accommodate dispensing of beverage components into a cup held beneath the dispensing head. The valve 40, as illustrated, is for dispensing one beverage component at a time which, in a contemplated practice of the invention, is either a selected one of a plurality of concentrate beverage syrups or a diluent for the syrups. It also is contemplated that the valve 40 can be a post-mix beverage dispensing valve which, as is understood, would accommodate mixing and dispensing of two beverage components simultaneously, e.g., a selected concentrate beverage syrup and a selected diluent for the syrup, such as carbonated or still water.

In accordance with the invention, the aroma of beverage or a component of the beverage being dispensed is disseminated for olfactory sensory enjoyment by a customer, and for that purpose means are provided for disseminating the aroma of a beverage as it is dispensed from the valve 40. In a contemplated embodiment of the invention such dissemination means may include a fan 54 contained and suitably mounted by conventional means within the dispensing head 22, for example by being mounted on and carried at the upper end of the support arm 24 where it extends into the dispensing head housing. The fan 54 is operated when the valve 40 is opened to dispense beverage, and generates a flow of air across, and advantageously around and in surrounding relationship to, the beverage as it exits the valve, in order to disseminate the aroma of the beverage to a customer and/or to a selected target area. The fan may be operated just while the beverage or beverage component is being dispensed, or it may be controlled to also operate before and/or after a beverage or beverage component, such as concentrate syrup, is dispensed. To provide a path for a flow of air into contact with and advantageously around and in surrounding relationship with the beverage as it is being dispensed, so that an aroma of the beverage will be entrained in the airflow, a slatted or louvered opening 56 is provided in the housing back wall 32 behind or upstream from the fan 54, and a slatted or louvered opening 58 is also provided in the housing bottom wall 36 in front of or downstream from the fan and around the valve outlet opening 52. Operation of the fan during dispensing of a beverage draws air into the dispenser head housing through the back wall opening 56, and moves the airflow through the housing interior and then out of the housing through the bottom wall opening 58. Alternatively, the direction of operation of the fan can be reversed, such that operation of the fan during dispensing of a beverage draws air into the dispenser head housing through the bottom wall opening 58 and moves the airflow through the housing interior and then out of the housing through the back wall opening 56, which would be advantageous for the situation where the dispenser is crew operated and mounted such that its back wall opening 56 faces a customer, since the aroma of the beverage would then be carried by the airflow directly to the customer. As the air flow exits/enters the bottom wall opening 58, it flows or has flowed in contact with, around and generally in surrounding relationship to the stream of beverage exiting the valve outlet 50, thereby picking up and entraining the aroma of the beverage for dissemination to a customer or other target area.

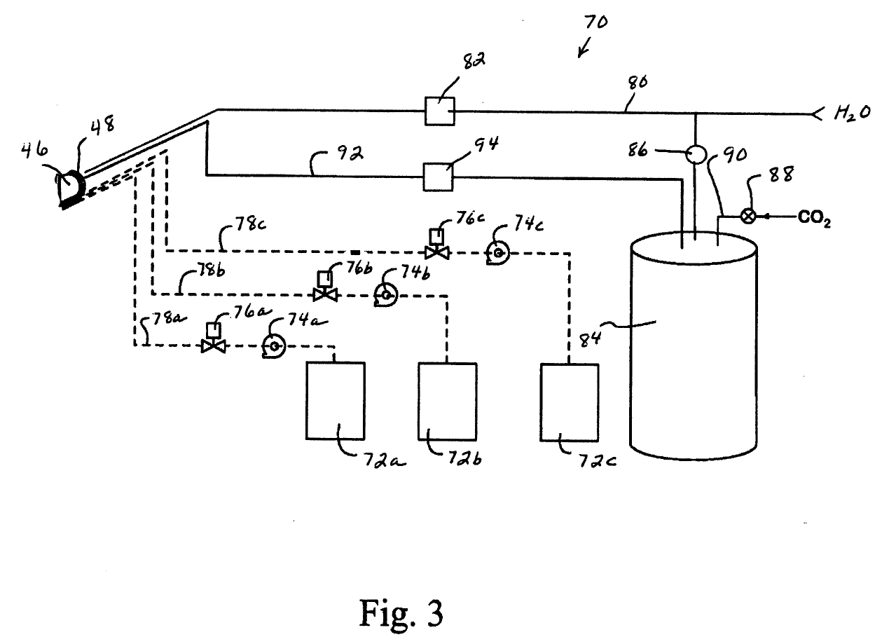

To control operation of the beverage dispenser in dispensing a beverage, as well as to control operation of the fan 54, a control interface or panel 60 is on a front surface of the housing front wall 34. The control panel 60 includes a plurality of manually actuable push-button switches 62, and a slot 64 in the front wall 34 accommodates electrical connection of the control panel with an electronic control board 66 contained within the dispensing head 22, whereby signals may be provided from the control panel to the control board. The control board 66 may advantageously include a microprocessor that is preprogrammed to perform selected dispensing functions in response to inputs from the control panel 60. Among the functions controlled by the control board 66 and microprocessor are operation of the fan 54 and of pumps and solenoid valves of a beverage component delivery system, as will be described in connection with FIG. 3.

Referring to FIG. 3, there is shown and indicated generally at 70 a beverage component delivery system of a type as may be used to deliver beverage components to a beverage dispensing station embodying the teachings of the invention, such as to the beverage dispensing station 20. The system is adapted to deliver to the beverage dispensing station beverage valve 40 a beverage component consisting of just one or more concentrate beverage syrups, of just a diluent for the syrup(s), or of both a selected one or more concentrate syrups and a diluent for the syrup(s). In the latter case, the syrup(s) and diluent may be delivered seriatim to the valve 40, or they may be delivered simultaneously if the valve 40 is of an appropriate type, such as where the valve is a post-mix beverage dispensing valve.

Provision is made in the beverage component delivery system 70 for delivery of a selected one or more of three different concentrate beverage syrups to the dispensing station 20, although it is understood and appreciated that the system can readily be configured to deliver fewer or more than three syrups to the dispensing station. The concentrate syrups are supplied in containers 72a, 72b and 72c, which may be of the bag-in-box type. To deliver the syrups from the containers 72a, 72b and 72c to the dispensing station 20, or to an additional one or more of multiple dispensing stations (only the dispensing station 20 being shown), an outlet from each container is coupled to an inlet to an associated metering pump 74a, 74b and 74c, which may be positive displacement metering pumps, such as gear or peristaltic pumps, or any other suitable type of pump that provides a metering function upon being energized for a selected period of time. An outlet from each pump is coupled to an inlet to an associated solenoid controlled valve 76a, 76b and 76c, outlets from which valves fluid couple through associated beverage syrup delivery tubes or lines 78a, 78b and 78c to the inlet end 48 of the support arm tube 46 for being coupled through the tube to the beverage dispensing valve 40. While the delivery lines 78a, 78b and 78c may terminate at the inlet 48 to the tube 46, so that the syrups are conveyed by the tube itself, advantageously they extend through the tube to the inlet to the dispensing valve 40 to prevent cross-contamination of beverage syrups.

Provision is made in the beverage component delivery system 70 for delivery of diluent for the syrups to the dispensing station 20, which in the case of soft drink beverages usually comprises carbonated and/or still water. For the purpose, the delivery system 70 includes a plain water delivery line 80 that is fluid coupled at its inlet to a source of potable water, such as to a city water main, and that extends through a metering and valving device 82 to the inlet 48 to the support arm tube 46 to deliver still water to the inlet 42 to the dispensing station valve 40. In addition, to provide carbonated water to the beverage dispensing station 20, the delivery system 70 includes a carbonator 84 that is filled and refilled with water from the line 80 by a pump 86. The carbonator is coupled to a supply of CO₂ though a regulator 88 and a line 90, thereby to carbonate water introduced into it in a manner well understood in the art, and delivers carbonated water to the inlet 48 to the support arm tube 46 through a carbonated water delivery line 92 and a metering and valving device 94. Advantageously, the plain and carbonated water delivery lines 80 and 92 extend through the tube 46 to the inlet 42 to the beverage dispensing valve 40.

As mentioned, in one contemplated practice of the invention, the beverage components of syrup and diluent are dispensed separately, and undiluted concentrate beverage syrup is dispensed by itself from the valve 40, to maximize the strength of the beverage aroma that is entrained in the airflow generated by the fan 54. Advantageously, the beverage syrup is sufficiently concentrated or appropriately formulated so that, upon dispensing of the syrup into a cup held beneath the dispensing station 20, a sufficiently strong aroma of the syrup, and therefore of the beverage, is entrained in the airflow disseminated to a customer to stimulate the olfactory sense of the customer. In this case, since undiluted syrup is dispensed into a cup, following dispense of the syrup, diluent is dispensed or added to the syrup in the cup, which diluent dispensing can occur at the same or at a separate beverage dispensing station. When concentrate syrup and diluent are dispensed at the same station, the concentrate syrup and diluent may be delivered seriatim to the valve 40, or they may be delivered simultaneously if the valve 40 is of a type that accommodates simultaneous dispensing of syrup and diluent, e.g., if the valve 40 is a post-mix valve. For the case where the syrup and diluent are dispensed simultaneously, the aroma of the diluted syrup entrained in the airflow may not be as strong as when the syrup is dispensed by itself.

Dispensing of concentrate beverage syrup or a constituted beverage at the dispensing station 20 is controlled through use of the push-buttons 62 of the keypad interface 60. In one contemplated operation of the system to dispense just syrup into a cup, a cup is placed below the outlet 50 from the beverage dispensing valve 40 at the beverage dispensing station 20. An appropriate push-button 62, representing the size of the cup and the particular concentrate beverage syrup to be dispensed, is then manually pressed to provide an input to the electronic control board 66. The electronic control board, in turn, controls operation of a selected one of the metering pumps 74a-c and its associated valve 76a-c for a programmed time that equates to the volume quantity of beverage syrup that is to be delivered into the cup, which in turn is in accordance with the size of the cup. If an additional flavor of concentrate beverage syrup is to be added to the cup a “+” push-button 62 may be pressed on the control panel 60, followed by actuation of an additional push-button representative of both the additional syrup concentrate to be added and the cup size. This action will again initiate operation of a selected one of the metering pumps 74a-c and its associated valve 76a-c for a programmed time that equates to the volume of syrup to be dispensed into the cup. During delivery or dispensing of syrup from the valve 40 into the cup, the control electronics 66 operates the fan 54 to generate a flow of air that contacts and passes across and advantageously around and in surrounding relationship to the syrup being dispensed, thereby to pick up or entrain in the airflow the aroma of the syrup(s) for dissemination to a customer for whom the drink is being prepared, or to an otherwise chosen target area. The solenoid valves 76a-c, which are opened to accommodate dispensing of syrup, are closed at the end of the syrup dispensing cycle to ensure termination of syrup supply to the dispensing valve 40, although it is contemplated that the system could, if desired, be operated without use of the solenoid valves 76a-c.

While the invention has been described in terms of dispensing soft drink beverages, it is understood by those of skill in the art that the invention can be used in the dispensing of other types of beverages, such as in the dispensing of coffee, tea, fruit juice, etc., the particular beverage dispensed being a matter of choice.

While embodiments of the invention have been described in detail, various modifications and other embodiments thereof may be devised by one skilled in the art without departing from the spirit and scope of the invention, as defined in the appended claims.

What is claimed is:

1. A beverage dispenser, comprising:
a beverage dispensing valve;
means for delivering beverage to said valve for being dispensed from said valve;
means for generating a flow of air that contacts the beverage being dispensed from said valve to entrain in the air an aroma of the beverage; and
means for disseminating the beverage aroma entraining air.

2. A beverage dispenser as in claim 1, wherein said generating means generates a flow of air generally surrounding the beverage while the beverage is being dispensed.

3. A beverage dispenser as in claim 1, wherein said means for disseminating directs the beverage aroma entraining air toward a desired location.

4. A beverage dispenser as in claim 1, wherein said delivering means delivers concentrate beverage syrup to said valve, and said generating means generates a flow of air that contacts the concentrate syrup being dispensed from said valve.

5. A beverage dispenser as in claim 1, wherein said delivering means delivers concentrate beverage syrup and diluent for the syrup to said valve, and said generating means generates a flow of air that contacts the concentrate syrup and diluent being dispensed from said valve

6. A beverage dispenser as in claim 1, wherein said means for delivering comprises a beverage delivery system for connection to a plurality of supplies of concentrate beverage syrup, and metering pump means for delivering predetermined amounts of the concentrate syrups to said beverage dispensing valve.

7. A beverage dispenser as in claim 6, wherein said beverage delivery system includes means for coupling to a supply of still water and a carbonator for delivering either still or carbonated water to said beverage dispensing valve.

8. A beverage dispenser as in claim 1, including a housing; means for mounting said beverage dispensing valve in an interior of said housing; means for admitting air into said housing interior; means for exhausting air from said housing interior; and air motive means for moving ambient air through said air admitting means into, through and out of said housing interior through said air exhausting means in a direction for contact of the air with the beverage being dispensed from said beverage dispensing valve.

9. A beverage dispenser as in claim 8, wherein said air motive means comprises a fan.

10. A beverage dispenser as in claim 8, wherein one of said air admitting means and said exhausting means comprises an opening in said housing in surrounding relationship with an outlet from said beverage dispensing valve for movement of air by said air motive means in surrounding relationship with beverage being dispensed from said valve.

11. A method of dispensing beverage, comprising the steps of:
delivering beverage to a beverage dispensing valve;
dispensing beverage from the valve;
generating a flow of air that contacts beverage being dispensed from the valve to entrain in the air an aroma of the beverage;
and disseminating the aroma entraining air.

12. A method as in claim 11, wherein said generating step generates a flow of air around and generally surrounding the beverage while the beverage is being dispensed from the valve.

13. A method as in claim 11, wherein said disseminating step directs the beverage aroma entraining air toward a desired location.

14. A method as in claim 11, wherein said delivering step delivers concentrate beverage syrup to the dispensing valve, and said generating step generates a flow of air that contacts the concentrate syrup being dispensed from the valve.

15. A method as in claim 11, wherein said delivering step delivers concentrate beverage syrup and diluent for the syrup to the beverage dispensing valve, and said generating step generates a flow of air that contacts the concentrate syrup and diluent being dispensed from the valve

16. A method as in claim 11, wherein said delivering step comprises the steps of coupling a plurality of supplies of concentrate beverage syrup to the beverage dispensing valve, and using metering pumps to deliver predetermined amounts of the concentrate syrups to the beverage dispensing valve.

17. A method as in claim 16, wherein said delivering step further includes the step of coupling a carbonator to the beverage dispensing valve.

18. A method as in claim 11, including the steps of mounting the beverage dispensing valve in an interior of a housing; providing an entry for air into the housing interior; providing an exit for air from the housing interior; and moving ambient air through the air entry into, through and out of the housing interior through the air exit in a direction for contact of the air with the beverage being dispensed from the beverage dispensing valve.

19. A method as in claim 18, wherein said ambient air moving step is performed with a fan.

20. A method as in claim 18, wherein one of said air exit and entry providing steps comprises providing an opening from the housing interior in surrounding relationship with an outlet from the beverage dispensing valve for flow of air in surrounding relationship with beverage being dispensed from the valve.
